(19) United States
(12) Patent Application Publication
(10) Pub. No.: US 2002/0131210 A1
(43) Pub. Date: Sep. 19, 2002

(54) Method of manufacturing head suspension assembly and head suspension assembly

(76) Inventor: Masaaki Habata, Higashiyamato-shi (JP)

Correspondence Address: PILLSBURY WINTHROP, LLP, P.O. BOX 10500, MCLEAN, VA, 22102, US

(21) Appl. No.: 10/091,546

(22) Filed: Mar. 7, 2002

(30) Foreign Application Priority Data
Mar. 14, 2001 (JP) 2001-072102

(51) Int. Cl. G11B 5/48

(52) U.S. Cl. 360/244.1

(57) ABSTRACT

In a head suspension assembly manufacturing method, a wiring pattern is formed, and a head amplifier IC is mounted on the wiring pattern. The wiring pattern, mounted with the head amplifier IC, is fixed on a suspension and an arm of the head suspension assembly.

### CROSS-REFERENCE TO RELATED APPLICATIONS

This application is based upon and claims the benefit of priority from the prior Japanese Patent Application No. 2001-072102, filed Mar. 14, 2001, the entire contents of which are incorporated herein by reference.

### BACKGROUND OF THE INVENTION

1. Field of the Invention

The present invention relates to a method of manufacturing a head suspension assembly used in a magnetic disc unit, and more particularly, to a method of manufacturing a head suspension assembly provided with a head amplifier IC and to the head suspension assembly.

2. Description of the Related Art

In general, a magnetic disc unit comprises a magnetic disc in a casing, a spindle motor that supports and rotates the disc, and a head suspension assembly that includes a magnetic head for reading from and writing information in the disc.

The head suspension assembly includes a slider having the magnetic head formed thereon, a suspension that supports the slider, and an arm that supports the suspension. A wiring pattern is fixed on the suspension and the arm, the slider is fixedly bonded to the wiring pattern, and the magnetic head is connected electrically to the wiring pattern.

The head suspension assembly is rotatably supported by means of a bearing assembly. As the assembly is rotated by means of a voice coil motor, the magnetic head can move to any desired position on the magnetic disc.

MR heads are widely used as magnetic heads these days. However, the MR heads are very easily affected by static electricity, so that they must be carefully handled in a magnetic head assembly process and a magnetic disc unit manufacturing process. The problem of static electricity can be effectively solved by somehow insulating the passage of excessive current that is attributable to electrostatic discharge. In a noticeable method to attain this, a head amplifier IC is mounted between a magnetic head and an electrode terminal of a head suspension assembly. Described in Jpn. Pat. Appln. KOKAI Publication No. 11-273044, for example, is a head suspension assembly that is mounted with a head amplifier IC.

In general, the distance between a head suspension assembly and the surface of a magnetic disc, which depends on the design of the magnetic disc unit, is adjusted to 0.3 to 0.5 mm. The head amplifier IC is formed of a bare chip. Currently mass-produced bare chips are about 0.3 mm thick. In the case of the head amplifier IC that is used in the head suspension assembly, the distance from the magnetic disc surface is so short as aforesaid that the bare chip should be further thinned.

If the head amplifier IC is thinned, however, dicing the IC from a wafer is liable to cause minute nicks or cracks in the IC body. If broken pieces of the head amplifier IC are scattered in the magnetic disc unit, they may possibly destroy data on the magnetic disc in the end. Even in the case where the head amplifier IC mounted on the head suspension assembly is reduced in thickness, moreover, the gap between itself and the magnetic disc surface is very short, ranging from 0.1 to 0.2 mm. Thus, if any external shock acts on the magnetic disc unit, there is a possibility of the head amplifier IC and the magnetic disc touching each other, thereby causing stored data to be destroyed.

Generally, in manufacturing the head suspension assembly of this type, a flexible printed circuit board (hereinafter referred to as FPC) having a desired wiring pattern is first fixed on an arm and a suspension. Thereafter, a slider having a magnetic head thereon and the head amplifier IC are fixed on the wiring pattern with an adhesive. Subsequently, electrodes on the slider and the head amplifier IC are connected electrically to their corresponding pad portions on the wiring pattern, whereupon the head suspension assembly is completed.

The electrodes on the slider and the head amplifier IC and the pad portions on the wiring pattern are connected by an ultrasonic bonding method, such as GBB (gold-ball bonding) or GGI (gold-gold interconnection). In carrying out this ultrasonic bonding method, the pad portions on the wiring pattern should be supported in the rear in order to prevent deformation of the wiring pattern. Since the wiring pattern is fixed on the arm and the suspension, it cannot directly support the pad portions. An opening is previously formed in that portion of the suspension which is opposed to the pad portions on the wiring pattern. The pad portions are supported by means of a jig through the opening during the ultrasonic bonding operation.

In the case where the slider is stuck on a tongue forming portion, in particular, the manufacture of the head suspension assembly requires processes of forming the opening and locating the jig through the opening. Thus, the manufacturing processes are complicated, so that the manufacturing cost may increase, and the wiring pattern may possibly be deformed as the slider is stuck on the tongue forming portion.

### BRIEF SUMMARY OF THE INVENTION

The present invention has been contrived in consideration of these circumstances, and its object is to provide a method of manufacturing a head suspension assembly, capable of easily manufacturing a head suspension assembly at lower cost, and the head suspension assembly.

In order to achieve the above object, a method of manufacturing a suspension assembly according to an aspect of the present invention comprises forming a wiring pattern, mounting a head amplifier IC on the wiring pattern, and fixing the wiring pattern, mounted with the head amplifier IC, on a suspension and an arm.

A method of manufacturing a suspension assembly according to another aspect of the invention comprises forming a wiring pattern having first and second principal surfaces, mounting a head amplifier IC on the first principal surface of the wiring pattern, inspecting the mounted head amplifier IC for operation through the wiring pattern, mounting a slider having a magnetic head on the second principal surface of the wiring pattern after normal operation of the head amplifier IC is confirmed by the inspection, and fixing the wiring pattern, mounted with the head amplifier IC and the magnetic head, on a suspension and an arm.

In a method of manufacturing a suspension assembly according still another aspect of the invention, the wiring pattern is fixed on the suspension and the arm after the outer surface of the head amplifier IC mounted on the wiring pattern is coated with a resin.

A method of manufacturing a suspension assembly according a further aspect of the invention comprises forming a wiring pattern sheet having a large number of wiring patterns, mounting a head amplifier IC on each wiring pattern of the wiring pattern sheet, cutting the wiring patterns, mounted with the head amplifier IC each, from the wiring pattern sheet, and fixing each cut wiring pattern on a suspension and an arm.

A method of manufacturing a suspension assembly according to an additional aspect of the invention comprises forming a wiring pattern sheet having a large number of wiring patterns, mounting a head amplifier IC on a first principal surface of each wiring pattern of the wiring pattern sheet, inspecting the mounted head amplifier IC for operation through each wiring pattern, mounting a slider having a magnetic head on a second principal surface of each of those wiring patterns on which the head amplifier IC's concluded to be normal in operation by the inspection are mounted, cutting the wiring patterns, mounted with the slider and the head amplifier IC each, from the wiring pattern sheet, and fixing each cut wiring pattern on a suspension and an arm.

A head suspension assembly according to an aspect of the invention comprises an arm, a suspension extending from the arm and having a proximal end portion fixed to the arm, a wiring pattern provided on the arm and the suspension, a head amplifier IC mounted on a first principal surface of the wiring pattern, and a slider mounted on a second principal surface of the wiring pattern and fitted with a magnetic head, the respective proximal end portions of the arm and the suspension having a opening penetrating the arm and the suspension, the wiring pattern being fitted on the suspension and the arm in a manner such that the first principal surface is opposed to the arm and the suspension, the head amplifier IC being located in the opening.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a perspective view showing an HDD provided with a head suspension assembly manufactured by a manufacturing method according to an embodiment of the present invention;

FIG. 2 is a perspective view showing a second principal surface side of the head suspension assembly;

FIG. 3 is a perspective view showing a first principal surface side of the head suspension assembly;

FIG. 4 is a sectional view of the head suspension assembly;

FIG. 5 is an enlarged sectional view showing a head amplifier IC portion of the head suspension assembly;

FIG. 6 is a plan view showing a wiring pattern sheet formed having a large number of wiring patterns in a process of manufacturing the head suspension assembly;

FIG. 7 is a perspective view showing head amplifier IC's mounted on the wiring pattern sheet;

FIG. 8 is a perspective view showing sliders mounted on the wiring pattern sheet;

FIG. 9 is an enlarged plan view partially showing wiring patterns on the wiring pattern sheet;

FIG. 10 is a perspective view showing a slider mounted on one of the wiring patterns in the process of manufacturing the head suspension assembly; and

FIG. 11 is an exploded perspective view showing a tracer, suspension, and arm that constitute the head suspension assembly.

### DETAILED DESCRIPTION OF THE INVENTION

There will now be described in detail a method of manufacturing a head suspension assembly and a head suspension assembly according to an embodiment of the present invention, with reference to the accompanying drawings.

The following is a description of the configuration of a hard disc drive (hereinafter referred to as HDD) as a magnetic disc apparatus that is provided with the head suspension assembly manufactured by the manufacturing method according to the present embodiment.

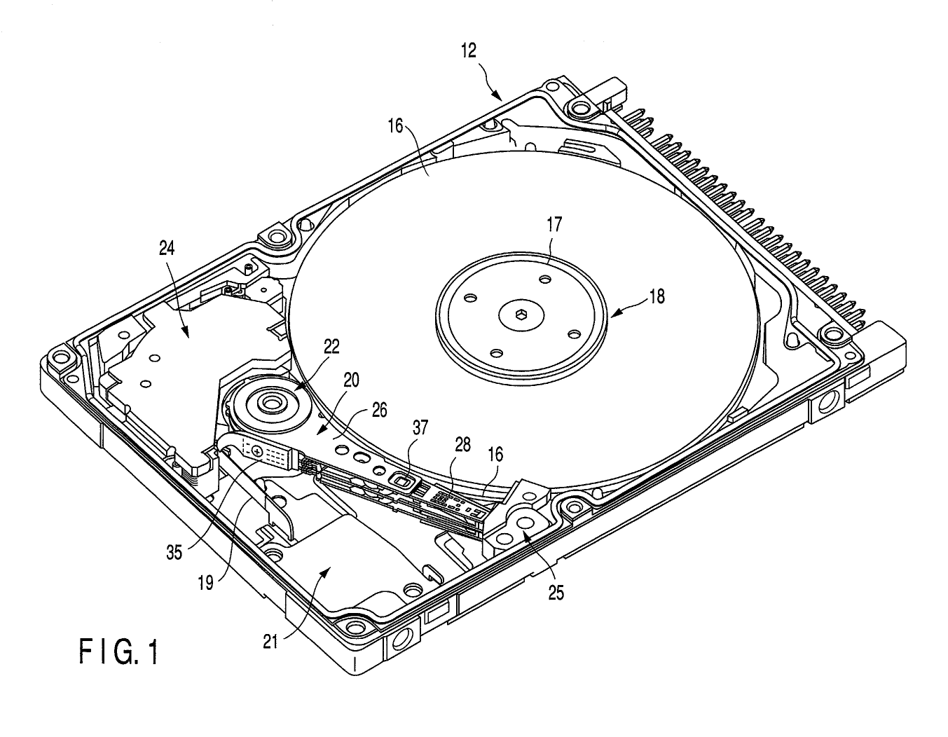

As shown in FIG. 1, the HDD comprises a casing 12 in the form of an open-topped rectangular box and a top cover (not shown) that is fixed to the casing by means of screws and covers the top opening of the casing.

The casing 12 is stored with, for example, two magnetic disc 16 for use as magnetic recording media, a spindle motor 18 that supports and rotates the discs 16, head suspension assemblies 20 that are provided individually with magnetic heads (mentioned later) for reading from and writing information in the magnetic discs 16, and a bearing assembly 22 that supports the head suspension assemblies 20 for rotating motion with respect to the magnetic discs 16. The casing 12 is further stored with a voice coil motor (hereinafter referred to as VCM) 24 for rotating and positioning the head suspension assemblies 20, a ramp load mechanism 25 that holds each magnetic head in a position distant from its corresponding magnetic disc when the head is moved to the outermost periphery of the disc, and a substrate unit 21.

Further, a printed circuit board (not shown) is screwed to the outer surface of the bottom wall of the casing 12. It serves to control the respective operations of the spindle motor 18, VCM 24, and magnetic heads by means of the substrate unit 21.

Each magnetic disc 16 has a diameter of 65 mm (2.5 inches) and carries magnetic recording layers on its upper and lower surfaces, individually. The magnetic discs 16 are coaxially fitted on a hub (not shown) of the spindle motor 18 and are held in position by a clamp spring 17. The two discs 16 are rotated at a given speed by the spindle motor 18.

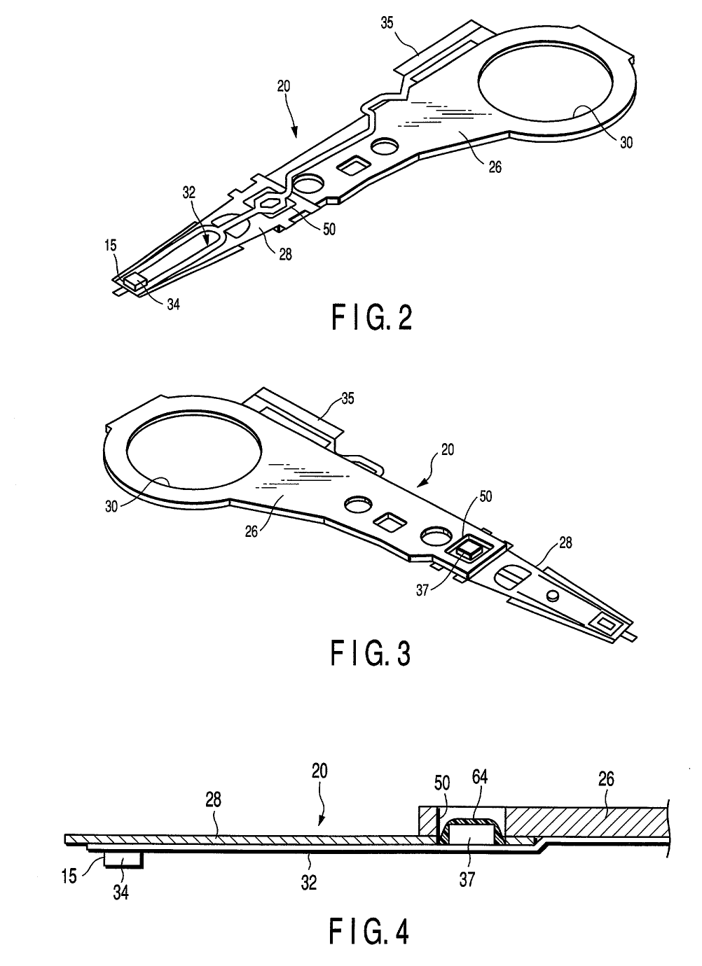

As shown in FIGS. 2 to 4, each head suspension assembly 20 comprises an arm 26 and a suspension 28. The suspension 28, having its proximal end fixed to the distal end of the arm 26 by spot welding or adhesive bonding, extends from the arm. The arm 26 is a thin flat sheet that is formed of a stainless-steel such as SUS304 and has a thickness of about 0.3 mm. The suspension 28 is formed of an elongate leaf spring with a thickness of 50 to 75 μm. The distal end portion of the arm 26 is formed having a substantially rectangular opening 50 that penetrates the arm and the suspension 28. The suspension 28 may be formed integrally and of the same material with the arm 26.

Further, each head suspension assembly 20 comprises a tracer 32, which is fixed on the suspension 28 and the arm 26, and a slider 34 and a head amplifier IC 37 that are mounted on the tracer.

The tracer 32 is in the form of an elongate band that includes a stainless-steel sheet and a relay FPC that has a wiring pattern. The tracer 32 is fixed on those respective surfaces of the suspension 28 and the arm 26 which are opposed to the magnetic discs, and extend from the distal end of the suspension 28 to a halfway portion of the arm 26. A soldering pad portion 35 that is provided on the proximal end portion of the tracer 32 extends outward from the arm 26.

The relay FPC of the tracer 32 includes the wiring pattern that has a plurality of conducting lines, which will be mentioned later. Each conducting line includes a pad portion to be connected with each magnetic head and a pad portion to be connected with the head amplifier IC 37. Further, the soldering pad portion 35 of the tracer 32 constitutes a connecting end portion of the tracer 32 and includes electrode pads as many as the conducting lines. As shown in FIG. 1, the pad portion 35 is connected to a main FPC 19 that extends from the substrate unit 21.

On the other hand, the slider 34 is mounted on that surface (second principal surface) of the tracer 32 which is opposed to the magnetic disc 16, and is supported on the distal end portion of the suspension 28. A magnetic head 15 for use as an electromagnetic transducer is formed on the distal end face of the slider 34. Electrodes of the magnetic head 15 are soldered to their corresponding pad portions of the wiring pattern.

The slider 34 is pressurized toward the magnetic disc by means of the suspension 28 that functions as a leaf spring. Further, the slider 34 serves to lift the magnetic head 15 for a substantially fixed distance above the magnetic disc surface by means of air pressure that is produced as the magnetic disc 16 rotates when the HDD is actuated. The magnetic head 15 is a composite-separate magnetic head that includes an MR element (magneto-resistive effect element) for reproduction (reading) and a thin-film head for recording (writing).

The head amplifier IC 37 is mounted on that surface (first principal surface) of the tracer 32 which is opposed to the suspension 28 and the arm 26, and is supported on the proximal end portion of the suspension. The IC 37 is held in the opening 50 that is formed in the suspension 28 and the arm 26.

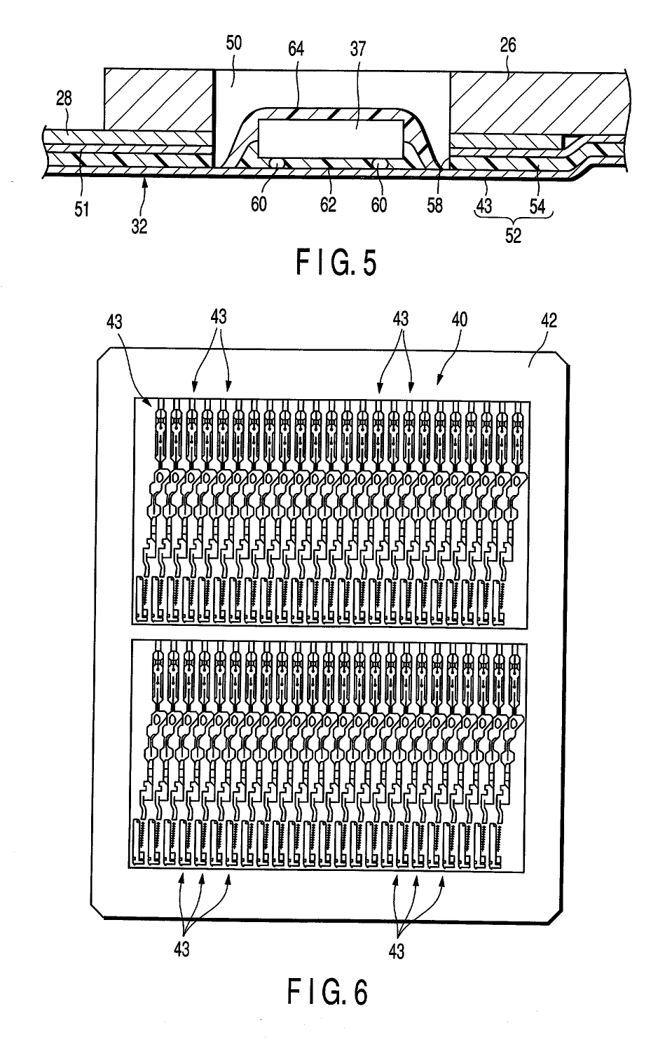

As shown in FIG. 5, a relay FPC 52 that constitutes the tracer 32 includes an insulating layer 54 of polyimide or the like formed on a stainless-steel sheet 51 and a wiring pattern 43 formed on the insulating layer. In the region on which the head amplifier IC 37 is mounted, the stainless-steel 51 and the insulating layer 54 of the tracer 32 are formed having an opening 58 through which the wiring pattern 43 is exposed. The head amplifier IC 37 is located in the opening 58 and soldered to a pad portion of the wiring pattern 43 by means of bumps 60.

The head amplifier IC 37 is formed of a bare chip with a thickness of 0.05 to 0.3 mm. A gap between the IC 37 and the tracer 32 is loaded with an under-fill 62, a resin, by pouring. A thin resin film 64 with a thickness of, for example, 10 to 20 μm covers the whole outer surface of the IC 37.

The soldering pad portion 35 of the tracer 32 is connected to the main FPC 19 that extends from the substrate unit 21. Thus, the magnetic head 15 and the head amplifier IC 37 are connected electrically to the substrate unit 21 of the HDD through the wiring pattern 43.

The head suspension assembly 20 constructed in this manner is attached to the bearing assembly 22 in a manner such that a hub of the bearing assembly is passed through an aperture 30 of the arm 26, and can be rotated around the bearing assembly by the VCM 24. As the head suspension assembly 20 rotates, the magnetic head 15 that is supported on the distal end portion of the suspension 28 is moved substantially in the radial direction of the magnetic disc 16.

The following is a description of the method of manufacturing the head suspension assembly constructed in this manner.

First, a wiring pattern sheet 40 that has a large number of wiring patterns 43 of the same shape arranged on the insulating layer is formed on a stainless-steel substrate 42, as shown in FIG. 6. The wiring pattern sheet 40 is formed by providing a copper foil on an insulating layer, patterning the copper foil into a given shape by photo-etching or the like, and then putting another insulating layer on the resulting structure, as in the process of forming a normal FPC.

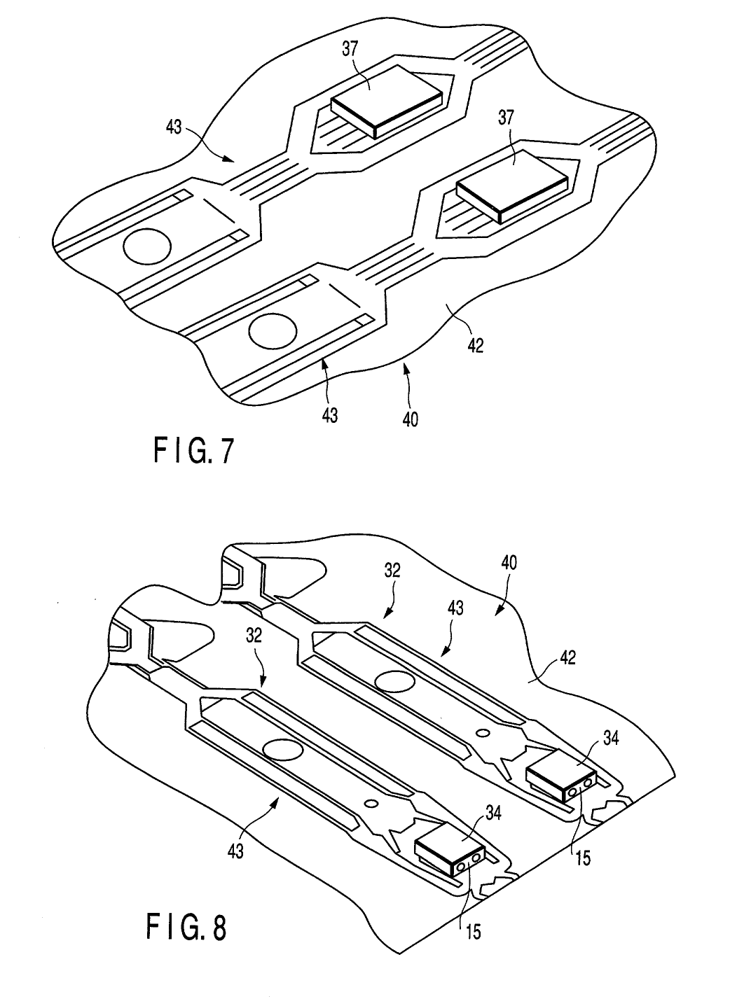

Subsequently, the head amplifier IC 37 is located in the opening 58 that is formed as an IC mounting portion of each wiring pattern 43, as shown in FIG. 7. Thereafter, the head amplifier IC 37 is connected electrically to the wiring pattern 43 by GBB, reflowing, etc. and mounted on the first principal surface of the wiring pattern. After the gap between each head amplifier IC 37 and the wiring pattern 43 is then loaded with the under-fill 62, the whole outer surface of the head amplifier IC is covered by means of the resin film 64. Thus, the head amplifier IC 37 is mounted on each wiring pattern 43 of the wiring pattern sheet 40.

Subsequently, an operation inspection is carried out to see if each head amplifier IC 37 operates normally. In this case, a DC or high-frequency signal is applied to each head amplifier IC 37 through each corresponding wiring pattern 43 by means of an inspection probe (not shown), whereby the head amplifier IC is checked for its state of operation.

Then, the sliders 34 are mounted individually on the respective wiring patterns 43 of the wiring pattern sheet 40, as shown in FIG. 8. In doing this, the sliders 34 are mounted only on those wiring patterns 43 on which the head amplifier IC's 37 that are concluded to be normal in operation in the aforesaid inspection are mounted. Further, each slider 34 is mounted on the second principal surface of its corresponding wiring pattern 43.

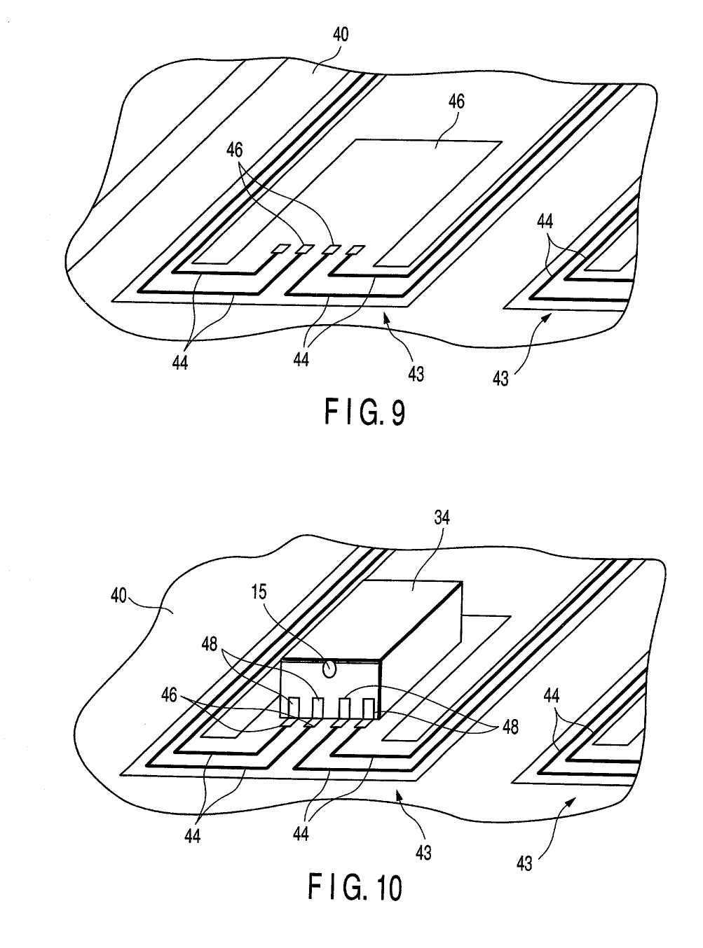

As shown in FIG. 9, each wiring pattern 43 has a plurality of conducting lines 44, the respective distal ends of which extend to their corresponding electrode pads 46 that are arranged on each tongue forming portion 45 of the wiring pattern sheet 40. Then, each slider 34 that is previously formed having the magnetic head 15 thereon is bonded to its corresponding tongue forming portion 45 of the wiring pattern sheet 40 with an epoxy adhesive, for example, as shown in FIG. 10. Thereafter, the electrode pads 46 on each wiring pattern 43 and their corresponding electrodes 48 on the slider 34 are connected electrically to one another by GBB or the like.

Thus, the wiring pattern sheet 40 is formed having a large number of wiring patterns 43 on which the sliders 34 and the head amplifier IC's 37 are mounted individually. Thereafter, the wiring patterns 43 on which the head amplifier IC's 37 and the sliders 34 are mounted, along with the stainless-steel substrate 42, are cut from the wiring pattern sheet 40. Thereupon, the tracers 32 of the given shape are formed having their respective wiring patterns 43 mounted individually with the head amplifier IC's 37 and the sliders 34.

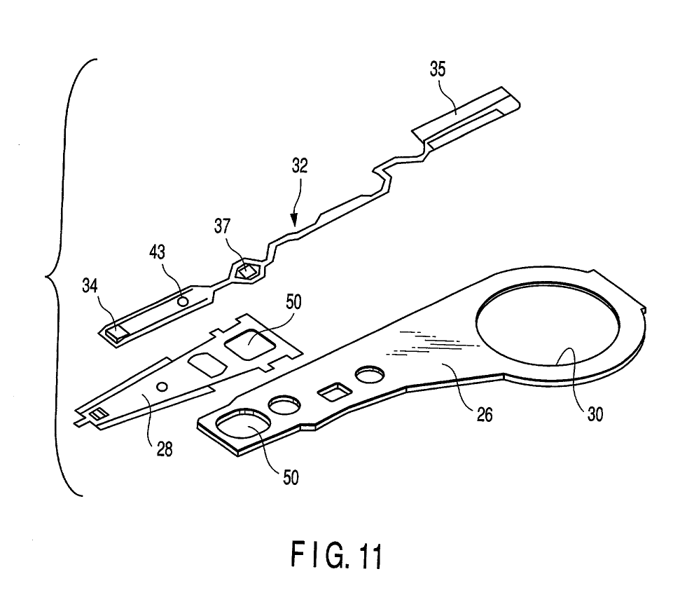

The head suspension assembly 20 shown in FIG. 2 is completed in a manner such that each tracer 32 previously mounted with the head amplifier IC 37 and the slider 34, each suspension 28, and each arm 26 are coupled to each other by laser welding or the like, as shown in FIG. 11.

According to the method of manufacturing the head suspension assembly constructed in this manner, the wiring pattern is fixed on the suspension and the arm after the head amplifier IC and the slider 34 are mounted on the wiring pattern. It is easy, therefore, to mount the head amplifier IC on the wiring pattern and cover the head amplifier IC, so that the manufacturing processes are facilitated, and therefore, the manufacturing cost can be lowered.

Further, the magnetic heads can be mounted to be used in the head suspension assemblies 20 only for the wiring patterns having those head amplifier IC's which are inspected and concluded to be normal in operation. Accordingly, production of defectives can be reduced, and expenditures on useless components can be cut, so that the manufacturing cost can be lowered.

Thus, there may be provided a head suspension assembly manufacturing method by which head suspensions can be manufactured with ease and the manufacturing cost can be lowered and a head suspension assembly manufactured thereby.

Further, the head amplifier IC's and the sliders can be mounted on a large number of wiring patterns that are formed on the wiring pattern sheet. Therefore, the manufacturing efficiency can be made much higher than in the conventional case where the head amplifier IC's and the sliders are mounted on the individual wiring patterns that are fixed individually on the suspensions.

According to the head suspension assembly 20 constructed in this manner, the head amplifier IC 37 is provided on the side opposite from the magnetic disc surface, and at the same time, is located in the opening 50 in the suspension 28 and the arm 26. If the head amplifier IC, formed of a bare chip, is broken, therefore, broken pieces can be prevented from falling onto the magnetic disc. If the HDD is heavily shocked, moreover, the head amplifier IC 37 and the magnetic disc 16 can be prevented from running against each other.

Since the head amplifier IC 37 is located in the opening 50, moreover, it never hinders the assembly of the HDD, so that the assembly efficiency is improved. Since the head amplifier IC 37 never touches an assembly jig, furthermore, it can be securely prevented from being damaged. Usually, the arm 26 has a thickness of 0.25 to 0.35 mm. In the case where the head amplifier IC is held in the opening 50 in the arm, therefore, its thickness can be adjusted to 0.20 to 0.25 mm without influencing the gap between the IC and the magnetic disc surface. Thus, the productivity for the IC can be improved, and generation of defects during dicing operation can be reduced. In consequence, there may be provided a head suspension assembly that ensures reduction in manufacturing cost and improved reliability.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For example, the specific shape of the wiring patterns, mounting method for the head amplifier IC and the slider on each wiring pattern, etc. may be variously selected as required. According to the foregoing embodiment, moreover, the slider and the head amplifier IC are mounted on each wiring pattern of the wiring pattern sheet. Alternatively, however, the slider or the head amplifier IC may be mounted on each wiring pattern after the wiring patterns are cut from the wiring pattern sheet to form the tracers.

What is claimed is:

1. A method of manufacturing a head suspension assembly comprising:
forming a wiring pattern;
mounting a head amplifier IC on the wiring pattern; and
fixing the wiring pattern, mounted with the head amplifier IC, on a suspension and an arm.

2. A method of manufacturing a head suspension assembly comprising:
forming a wiring pattern having first and second principal surfaces;
mounting a head amplifier IC on the first principal surface of the wiring pattern;
inspecting the mounted head amplifier IC for operation through the wiring pattern;
mounting a slider having a magnetic head on the second principal surface of the wiring pattern after normal operation of the head amplifier IC is confirmed by the inspection; and
fixing the wiring pattern, mounted with the head amplifier IC and the magnetic head, on a suspension and an arm.

3. A method of manufacturing a head suspension assembly according to claim 1, wherein said wiring pattern is fixed on the suspension and the arm after the outer surface of the head amplifier IC mounted on the wiring pattern is coated with a resin.

4. A method of manufacturing a head suspension assembly according to claim 1, wherein said wiring pattern is fitted on the suspension and the arm so that the mounted surface of the head amplifier IC is opposed to the suspension and the arm, and said head amplifier IC is located in an opening formed in the suspension and the arm.

5. A method of manufacturing a head suspension assembly comprising:
forming a wiring pattern sheet having a number of wiring patterns;
mounting a head amplifier IC on each wiring pattern of the wiring pattern sheet;
cutting the wiring patterns, mounted with the head amplifier IC each, from the wiring pattern sheet; and
fixing each cut wiring pattern on a suspension and an arm.

6. A method of manufacturing a head suspension assembly according to claim 5, wherein each of said wiring patterns is cut from the wiring pattern sheet after the outer surface of the head amplifier IC mounted on the wiring pattern is coated with a resin.

7. A method of manufacturing a head suspension assembly according to claim 5, wherein each of said wiring patterns is fitted on the suspension and the arm so that the mounted surface of the head amplifier IC is opposed to the suspension and the arm, and said head amplifier IC is located in an opening formed in the suspension and the arm.

8. A method of manufacturing a head suspension assembly comprising:
forming a wiring pattern sheet having a number of wiring patterns;
mounting a head amplifier IC on a first principal surface of each wiring pattern of the wiring pattern sheet;
inspecting the mounted head amplifier IC for operation through each wiring pattern;
mounting a slider having a magnetic head on a second principal surface of each of those wiring patterns on which the head amplifier IC's concluded to be normal in operation by the inspection are mounted;
cutting the wiring patterns, mounted with the slider and the head amplifier IC each, from the wiring pattern sheet; and
fixing each cut wiring pattern on a suspension and an arm.

9. A method of manufacturing a head suspension assembly according to claim 8, wherein each of said wiring patterns is cut from the wiring pattern sheet after the outer surface of the head amplifier IC mounted on the wiring pattern is coated with a resin.

10. A method of manufacturing a head suspension assembly according to claim 8, wherein each of said wiring patterns is fitted on the suspension and the arm so that the mounted surface of the head amplifier IC is opposed to the suspension and the arm, and said head amplifier IC is located in an opening formed in the suspension and the arm.

11. A head suspension assembly comprising:
an arm;
a suspension extending from the arm and having a proximal end portion fixed to the arm;
a wiring pattern provided on the arm and the suspension;
a head amplifier IC mounted on a first principal surface of the wiring pattern; and
a slider mounted on a second principal surface of the wiring pattern and fitted with a magnetic head,
the respective proximal end portions of the arm and the suspension having a opening penetrating the arm and the suspension,
the wiring pattern being fitted on the suspension and the arm in a manner such that the first principal surface is opposed to the arm and the suspension, and the head amplifier IC being located in the opening.

12. A head suspension assembly according to claim 11, wherein said head amplifier IC is formed of a bare chip, and the outer surface of said head amplifier IC is coated with a resin.
